(19) United States
(12) Patent Application Publication
(10) Pub. No.: US 2020/0049133 A1
(43) Pub. Date: Feb. 13, 2020

(54) GRAVITY ROTATION DEVICE

(71) Applicants: Christian PELLEGRIN, Marseille (FR); Philippe PELLEGRIN, Escalles (FR)

(72) Inventor: Christian PELLEGRIN, Marseille (FR)

(73) Assignees: Christian PELLEGRIN, Marseille (FR); Philippe PELLEGRIN, Escalles (FR)

(21) Appl. No.: 16/554,947

(22) Filed: Aug. 29, 2019

Related U.S. Application Data
(63) Continuation-in-part of application No. 14/917,088, filed on Mar. 7, 2016, now abandoned.

(30) Foreign Application Priority Data
Sep. 23, 2013 (FR) 13 59120

(51) Int. Cl. F03G 3/00; F16H 1/28

(52) U.S. Cl. CPC F03G 3/00; F16H 1/28

(57) ABSTRACT

A gravity rotary device including a first disk having a central axis; a peripheral axis of rotation arranged at a distance from and parallel to the central axis; a peripheral rotary shaft suitable for turning about the peripheral axis of rotation; and a mass support mounted on the peripheral rotary shaft and having a mass suitable for being moved away from the rotary shaft in order to produce torque causing the rotary shaft and the first disk to pivot. The device also includes a reduction gearing arranged between the peripheral rotary shaft and the first disk; a means for fastening at least a portion of the reduction gearing in a stationary position in order to prevent it from turning about the peripheral axis of rotation; a freewheel arranged on the peripheral rotary shaft; and means for modifying the angle of inclination of a mass support on the peripheral rotary shaft.

### SUMMARY OF THE INVENTION

The present invention relates to a gravity rotation device and to a method of rotating such a device.

### BACKGROUND OF THE INVENTION

For a long time, there has been a desire to find a gravity rotation device that uses gravitational energy produced by one or more masses moving downwards. Such devices often comprise disks driven in rotation by torque produced by a mass that is moved away from an axis of rotation, the torque that is produced serving to drive the disk in rotation, and consequently to drive a drive shaft in rotation, for example.

The torque contributes to rotating the device while moving downwards. In contrast, while moving upwards, so long as the mass remains at the same distance from the axis of rotation, it produces an opposing torque that brakes rotation of the device. That is why known gravity rotation devices include mechanisms for varying the distance between the mass and the axis of rotation, depending on whether the mass is moving upwards or downwards.

Patent application FR 2 830 289 relates to a gravity rotation device comprising a disk that is rotatable about a rotary shaft, slideways oriented radially horizontally on the disk, and a motor. Two flyweights are carried by a rack mounted on the slideways. The flyweights are suitable for moving towards or away from the rotary shaft of the disk in the same direction under the action of the motor which causes the rack to move in translation and thus causes the flyweights to move along the slideways, thereby causing the disk to rotate.

Patent application WO 02/070893 relates to a gravity rotation device comprising a closed support in the form of a disk, a rotary shaft, and hemispherical masses. The support is stationary and the rotary shaft is off-center relative to the center of the disk. The masses are suitable for turning about the shaft and they drive the shaft in rotation. For this purpose, pairs of masses are slidably mounted on rods fastened to opposite sides of the rotary shaft. Cylindrical springs are mounted on each rod between the mass and the end of the rotary shaft in order to control the distance between the mass and the rotary shaft. During downward movement of a mass, the spring is compressed by the mass coming into contact against the outer wall of the disk. During the stage in which the mass is rising, the spring is relaxed. Thus, by the action of the spring, for each pair of masses, the mass moving downwards is further away from the rotary shaft and the mass moving downwards is closer to the rotary shaft.

Patent application FR 2 812 348 describes a gravity rotation device having two sprockets, a chain, and hook-shaped supports on which masses extending in a longitudinal direction are arranged. The sprockets have axes of rotation that are parallel and they are vertically offset from each other, the chain being tensioned between the two sprockets. The supports are fastened to the chain and they drive it in rotation, and consequently they drive the sprockets in rotation, as a result of the masses present on the support. The masses move freely in the direction in which the support is inclined, moving away from the chain in the upward direction and towards the chain in the downward direction. In a vertical position at the bottom of the device, a support releases the corresponding mass, which is caught by a slideway arranged under the bottom sprocket. The support turns round after going round the bottom sprocket and recovers the mass released by the preceding support. The mass is arranged at the inner end of the support for the upward stage. On arriving at the top of the top sprocket, while the support is turning round, the mass rolls away and drops onto the following support. Because of the downward inclination of the support, the mass occupies the outer end of the support where it is held by the hooks during the downward stage.

Patent application CN 2603229 relates to a device having a toothed wheel configured to pivot about a central axis and connected to two gear systems, a weight and a counterweight mounted on the ends of a bar connected to the wheel, the bar having an axis perpendicular to the central axis and offset relative to the center of the wheel. In order to put the device into operation, a weight is pivoted 180° around the perpendicular axis, thereby causing the wheel to make half a turn, until the device reaches equilibrium. Thereafter, the weight is pivoted once more through 180° about the perpendicular axis. The wheel makes another half-turn, and returns to the initial position.

Patent application CN 1525063 relates to a similar device also having a second toothed wheel facing the first, together with a weight and a counterweight mounted in the same manner. The high weights move towards each other and the wheels turn independently in opposite directions, each through half a turn.

Patent application US 2008/011552 relates to a device having swing arms fastened in rotatable manner about a central portion and weights mounted slidably on a bar mounted on the swing arms, each bar having wheels at its ends that are held in a stationary rail defining an asymmetrical path around the central section. Rotary movement is produced by the difference in spacing between the axis of the rail and the position of a wheel that is to be found in succession in each cycle close to and then far from the axis, thereby creating driving torque.

FIG. 1 is a side view of a rotary shaft 1 described in U.S. Pat. No. 5,921,133. The device 1 is mounted on a support 2 and comprises a first disk 3, a second disk 4, each having a respective weight 5, 6 that is “unbalanced”, i.e. having its center of gravity off-center relative to the center of the disk and presenting weight that cannot be compensated by another mass so as to bring the center of gravity to the center of the disk. The disks 3 and 4 are in axial alignment and they are connected together by a support shaft 7 so as to be capable of turning about a central axis of rotation AA′. A primary one-way directional clutch (or “freewheel”) 8 is mounted on the shaft 7. A plurality of gears 9 are mounted equidistantly around the outside of the periphery of the first disk 3, the peripheries of the disk 3 and of the gears 9 carrying teeth so that they co-operate with one another. Each gear 9 has a rotary shaft 10 passing therethrough that is oriented along a peripheral axis of rotation BB′. A “lever” weight 11 is mounted on each shaft 10. The shaft 10 thus mechanically couples together the gears 9 and the disk 4. Secondary freewheels 12 are arranged between the rotary shafts 10, the gears 9, and the disk 4 so that rotation of the lever 11 around the rotary shaft 10 is transmitted to the second disk 4.

According to that document, the unbalanced weights 5, 6 initially drive the device 1 in rotation. Thereafter, the levers 11 begin to pivot and cause the disk 3 to turn faster than the disk 4 because of the primary freewheel 8. The disk 3 begins to turn faster than the disk 4 since the disk 3 is urged in the counterclockwise direction by the gears 9. Because of their different speeds, the weights 5, 6 of the disks 3, 4 begin to move away and the wheel 3 turns with increasing speed for about two-thirds of a rotary cycle and with decreasing speed during about one-third of a rotary cycle, while the unbalanced mass 5 of the disk 2 comes closer to the unbalanced mass 6 of the wheel 4.

It would be desirable to provide a novel gravity rotation device.

Embodiments of the invention relate to a gravity rotary device comprising a first disk comprising a central axis about which the disk is capable of turning, and at least one peripheral axis of rotation arranged at a distance from and parallel to the central axis, at least one peripheral rotary shaft arranged at a distance from the central axis of the first disk, and suitable for turning about the peripheral axis of rotation, parallel to the central axis, and coupled to the first disk, and at least one mass support mounted on the peripheral rotary shaft and having a mass suitable for being moved away from the rotary shaft in order to produce torque causing the rotary shaft and consequently the first disk to pivot.

At no time during the cycle does the device perform a yield greater than 1. Indeed, each installed mass produces an eccentric motor torque to which it is necessary to subtract the friction losses. Accordingly, there is no question of obtaining a yield greater than 1.

On a disk of center O, creation of a motor torque by the installation on the periphery of bars doors masses longer than the radius, in four points located in cross. These bars are located on the disc via a uni-directional clutch, equipped with a mass at the end and positioned horizontally. They exert an eccentric motor torque of a different value depending on their position in the kinematics. This torque is active on about 90° of arc, the energy produced causes the rotating support, which stops after a few turns.

Several functioning objectives of the invention are explained below.

Objective: To increase the presence of the motor torque on an arc of more than 180°.

One of the solutions is to perform an assembly of connecting the ground support disk to a second disk and transmitting the motor torque thereto by a gear system configured such that the transmission ratio is 1/16. Therefore, if the ground bar is horizontal at the top at the zero position, after a complete revolution of the support disk, the bar will be at an angular position of 22.5° below the horizontal. It is these 22.5° consumed for a complete cycle that must be reconstituted. In other words, the driving torque of each bar is active on 337.5° arc regardless of its position in the cycle.

Objective: To reconstruct the angular potential consumed at each cycle.

One of the solutions is to position the starting point of the kinematics so that the mass carriers are horizontal at the 90° point. At this moment, wheels are coming into contact with a motorized circular cam, which holds and carries the mass holder until the angular value of 22.5° above the horizontal is found. During this phase the other masses are in driving positions, their couples still active, the system turns normally balancing itself according to the principle of speed controllers by kinetic energy. Without this function the system would stop itself by placing the load bars vertically.

Objective: To install the generating masses of the motor torque and the function “on-off” and “regulation”.

The dimensions of the device are those required for the desired power. The on-off and regulation function is ensured by a door bar moving system masses on their support, using gravity for some or all of the function and regulated by electronic and remote control.

Objective: Recovery of energy.

The recovery is done on one disc or more by a transmission shaft and clutch, toothed wheel, pulley and transmission belt or chain.

According to the invention, the device further comprises reduction gearing arranged between the peripheral rotary shaft and the first disk, the gearing comprising a rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk.

The disk further comprises means for fastening at least a portion of the reduction gearing in a stationary position in order to prevent it from turning about the peripheral axis of rotation; a freewheel arranged on the peripheral rotary shaft; and means for modifying the angle of inclination of a mass support on the peripheral rotary shaft relative to the horizontal passing through the peripheral axis of rotation of the shaft.

The device of the invention uses at least one mass support caused to move in rotation by a mass that is off-center relative to its axis of rotation. The off-center mass may be constituted by the mass support itself, providing its center of gravity is far enough away from its axis of rotation, or by a mass suspended from the mass support and serving to produce torque acting on the first disk in order to cause it to move in rotation. Since the number of revolutions performed by the first disk is limited by the angle of inclination of the mass support in its starting position, the device of the invention makes it possible to increase the number of revolutions that are performed by using reduction gearing (also referred to as a “reducer”) situated between the rotary shaft of the mass support and the first disk in order to increase the angular velocity of the first disk relative to the mass support. The particular structure of the reducer serves to increase the effectiveness with which the torque produced by the mass support is transmitted to the first disk.

In this embodiment, the device has means enabling the gravity potential energy to be recreated and enabling the number of revolutions that can be performed by the device to be increased. For this purpose, the angle of inclination of one or more mass supports is modified so as to recreate torque about one or more peripheral axes of rotation while the off-center mass that creates the torque is vertically located, or so as to prolong rotation of the mass support and thus the existence of torque production. The freewheel makes it possible to modify the angle of inclination in the direction opposite to the direction of rotation of the mass support while enabling the first disk to continue to turn in the same direction of rotation.

In an embodiment, the reduction gearing further comprises a peripheral ring connected to the rotary inlet part, an outlet gear connected to the rotary outlet part, and at least one planet gear arranged between the peripheral ring and the outlet gear, and the means for fastening at least a portion of the reduction gearing further comprise planet carriers fastened to the planet gears and locking parts fastened to the planet carriers.

In an embodiment, the device further comprises a second disk suitable for turning about a central axis and coupled to the first disk so that rotation of the first disk entrains rotation of the second disk, the means for fastening the portion of the reduction gearing being coupled to the second disk.

In this embodiment, the means for fastening the portion of the reduction gearing in a determined position are coupled to a second disk. Since the second disk turns in the same direction and at the same speed as the first disk, the portion of the reduction gearing remains in a position that is stationary relative to the first disk, while enabling the assembly to rotate and making effective the transmission of the torque produced by the mass support.

In an embodiment, the central axis of the second disk is off-center relative to the central axis of the first disk.

In this embodiment, the second disk is off-center relative to the first disk. This greatly simplifies provision of the reducer and connecting the fastener means of the planet gear to the second disk.

In an embodiment, the device comprises at least two peripheral rotary shafts, each being arranged at substantially the same distance from the central axis of the first disk and having a peripheral axis of rotation parallel to the central axis, coupled to the first disk, and angularly equidistant relative to the center of the first disk; and at least two mass supports, each mounted on a peripheral rotary shaft and having a mass suitable for being moved away from the peripheral rotary shaft in order to produce torque causing the peripheral rotary shaft, and consequently the first disk, to rotate.

In this embodiment, the device has at least two mass supports situated at the same distance from the central axis of the first disk and angularly equidistantly relative to the center of the first disk. The system can thus be kept in equilibrium when the at least two masses are situated on the axis of rotation of the mass support and it can be set into motion on moving one of the masses away from the axis of rotation.

In an embodiment, the first disk includes a central rotary shaft, and the second disk includes a central rotary shaft, the central rotary shafts being connected together by a connection part.

In this embodiment, the connection part helps support and turn the two disks by means of their central rotary shafts, which are generally quite strong.

In an embodiment, the device further comprises a support element connected to the central rotary shaft of the second disk while enabling the first disk and the second disk to turn.

In this embodiment, the support element enables the device to be moved away from the ground while allowing the disks to turn.

In an embodiment, the device further comprises a third disk arranged facing the first disk, suitable for turning about the central axis of the first disk, and supporting one end of the peripheral rotary shafts.

In this embodiment, when large masses are supported by the mass support, it is advantageous to use a third disk connected to the peripheral rotary shafts in order to share the load better.

In an embodiment, the means for modifying the angle comprise an internal cam having a guide surface and arranged on the first disk, and a follower wheel arranged on an inner surface of a mass support and suitable for coming into contact with the guide surface of the cam during rotation of the first disk in order to guide the rotation of the mass support in the direction opposite to the direction of rotation of the first disk, by virtue of the freewheel, and in order to change the angle of inclination of the mass support.

In this embodiment, the angle of inclination of the mass support is modified by guidance from a wheel following a cam, the cam being inside the rotary device. This provides a rotary device that is compact and that does not require the energy produced by the rotation of the disk to be reused for sustaining rotation of the rotary device.

In an embodiment, the means for modifying the angle comprise at least one external cam arranged facing the outer end of a mass support and including a guide surface, and a follower wheel arranged on an outer surface of a mass support and suitable for coming into contact with the guide surface of the cam during rotation of the first disk in order to guide the rotation of the mass support in the direction opposite to the direction of rotation of the first disk, by virtue of the freewheel and in order to change the angle of inclination of the mass support.

In this embodiment, the cam is external to the rotary device. This embodiment is particularly advantageous when the masses under consideration are relatively large.

In an embodiment, the device further comprises a motor connected to the external cam and suitable for driving the cam in rotation about an axis of rotation of the cam in the same direction as the direction of rotation of the first disk.

In this embodiment, a motor serves to drive the cam in rotation. The follower wheel does not slide against the surface of the cam and the cam is driven in rotation by the motor. This delivers external energy.

The motor also serves as a component of a system for resetting the device by recreating a torque around at least one peripheral axis of rotation, for example, by changing the inclination of the mass support to recreate gravitational potential energy and to increase the number of turns that can be made by the device. More generally, the means for resetting the device according to the present invention can include a cam and rolling roller system (FIGS. 8A, 8B, 9), outer cams with a motor (FIG. 10), or a motor and a cable system (FIG. 11).

In an embodiment, the mass support comprises two plates of triangular shape that are arranged at a distance apart from each other and in parallel planes, the plates being connected to each other by longitudinal support elements, with the top sides of the plates having rails; and wherein a mass-carrier bar is supported at its two ends by the rails and is suitable for moving along a direction along the top sides of the plates.

In this embodiment, the particular structure of the mass support enables large masses to be supported and enables the torque that is produced and transmitted to the first disk to be increased.

In an embodiment, each of the rails of the mass support includes a plurality of electromagnetic chocks suitable for rising in order to block movement of the mass-carrier bar and for lowering in order to allow the mass-carrier bar to move along the top sides of the plates.

In this embodiment, when the mass supports are inclined relative to the horizontal, the mass-carrier bar can move along the top sides of the plates along a direction d2 merely under the action of gravity. The electromagnetic chocks make it possible to release or to lock the position of the mass-carrier bar. It is thus possible, by varying the distance between the axis of rotation of the mass support and the off-center mass, to vary the torque that is produced.

Implementations of the invention also relate to a method of rotating a gravity rotation device of the invention, the method comprising the steps of: moving the mass of a mass support away from the peripheral rotary shaft in order to produce torque causing the peripheral rotary shaft to pivot and consequently causing the first disk to pivot; and modifying the angle of inclination of a mass support on the peripheral rotary shaft relative to the horizontal passing through the peripheral axis of the shaft.

The method of the invention makes it possible to set the system into operation by moving the mass away on the mass support. In this implementation, it is possible to recreate the gravity potential energy and to increase the number of revolutions that can be performed by the device by modifying the angle of inclination of a mass support relative to the peripheral axis of rotation.

Implementations of the invention also provide a method of assembling a gravity rotation device of the invention. The method comprises the steps of: mounting a first disk comprising: a central axis about which the disk is capable of turning; and at least one peripheral axis of rotation arranged at a distance from and parallel to the central axis; mounting at least one peripheral rotary shaft arranged at a distance from the central axis of the first disk, and suitable for turning about the peripheral axis of rotation, parallel to the central axis, and coupled to the first disk; mounting reduction gearing between the peripheral rotary shaft and the first disk, the reduction gearing comprising a rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk; mounting means for fastening at least a portion of the reduction gearing in a stationary position in order to prevent it from turning about the peripheral axis of rotation; mounting a freewheel on the peripheral rotary shaft; mounting at least one mass support on the peripheral rotary shaft, the mass support having a mass suitable for being moved away from the rotary shaft in order to produce torque causing the rotary shaft to pivot; and mounting means for modifying the angle of inclination of the mass support on the peripheral rotary shaft relative to the horizontal passing through the peripheral axis of rotation of the shaft.

Other characteristics and advantages of the present invention appear better on reading the following description made by way of non-limiting illustration and with reference to the accompanying drawings.

### BRIEF DESCRIPTION OF THE DRAWINGS

FIG. 1, described above, is a side view of a prior art rotary device;

FIGS. 2A to 2D show a first aspect of the operating principle of a rotary device;

FIGS. 3A and 3B show a second aspect of the operating principle of a rotary device;

FIGS. 4A to 4D are various views of a rotary device in a first embodiment;

FIG. 5 is a detailed section view of a reducer in an embodiment;

FIG. 6 is a perspective view of a rotary device in another embodiment;

FIG. 7 is a detailed perspective view of a mass support in an embodiment;

FIG. 8A shows a rotary device in another embodiment;

FIG. 8B is a perspective view of a mass support in another embodiment;

FIG. 9 is a face view of the FIG. 8A rotary device fitted with the FIG. 8B mass support;

FIG. 10 is a perspective view of a rotary device in another embodiment;

FIG. 11 is a face view of a rotation device in another embodiment;

FIG. 12 is a perspective view of a mass support in another embodiment; and

FIG. 13 is a detailed section view of a reducer in another embodiment.

FIG. 14 shows the operational principle of the rotary device.

FIG. 15 shows a revolution diagram of the rotary device in operation.

FIG. 16 shows the balance configuration of the rotary device in Test No. 1.

FIG. 17 shows a configuration of the rotary device after completing rotations in Test No. 1.

FIG. 18 shows a configuration of the rotary device after completing rotations in Test No. 2.

FIG. 19 shows a configuration of the rotary device after completing rotations in Test No. 3.

FIG. 20 shows a configuration of the rotary device after completing rotations in Test No. 4.

FIG. 21 shows a configuration of the rotary device after completing rotations in Test No. 5.

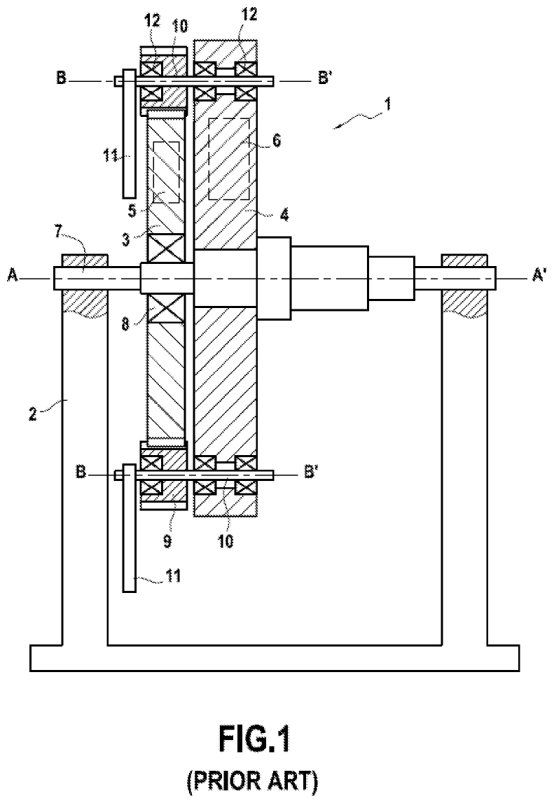

### DETAILED DESCRIPTION OF THE INVENTION

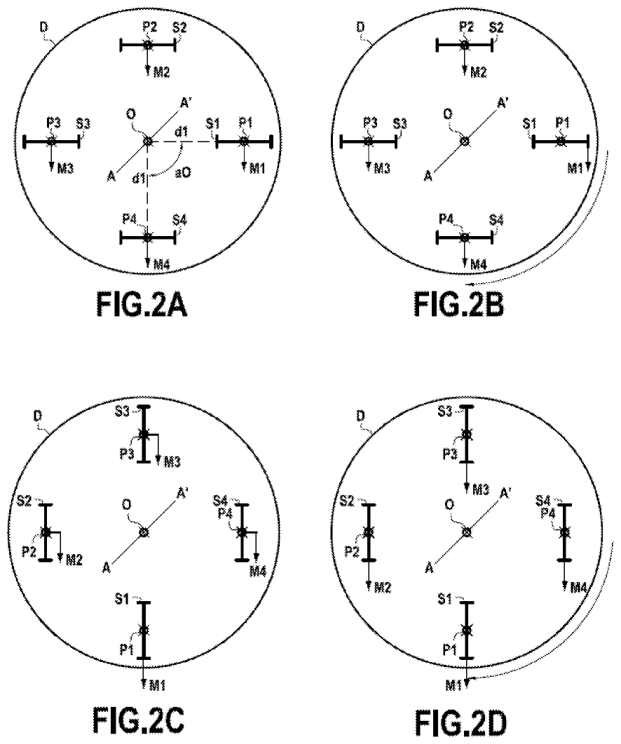

FIGS. 2A to 2D show a first aspect of the operating principle of a rotary device in which masses Mi create driving torques causing a disk D to rotate.

FIGS. 2A to 2D show the disk D of center O capable of turning about a central axis of rotation AA′, the axis AA′ being perpendicular to the disk D and passing through the center O of the disk. The disk D also has a plurality I of support bars Si (i being an index varying from 1 to I, with consideration being given in this example to four support bars S1, S2, S3, S4) that are fastened to the disk D at I fastener points Pi (in this example P1, P2, P3, P4) at the middle of each bar Si. The bars are stationary and parallel to one another. The fastener points Pi are arranged essentially at a distance d1 from the center of the disk. For each pair of adjacent points Pi, an angle a0 is formed between those two points and the center of the disk D. The angle a0 formed by each pair of adjacent points Pi is substantially the same.

A mass Mi (in this example M1, M2, M3, M4) is fastened on each bar Si and can be placed on either side of the fastener point Pi of the bar Si, producing torque either in the clockwise direction or in the counterclockwise direction.

In FIG. 2A, the bars Si are horizontal and each mass Mi is arranged in the middle (at the point Pi) of the corresponding bar Si. The system is in equilibrium and the disk D does not move.

In FIG. 2B, one of the masses, e.g. the mass M1, has been shifted and is located at one of the ends of the bar S1, to the right of the point P1. The mass M1 thus produces torque C1 about the point P1, thereby driving the disk D in rotation. The disk D turns in the same direction as the torque C1 and regardless of the position of the bar B1 (at the top, at the bottom, on the right, on the left) on the disk D.

In FIG. 2C, the system is once more in equilibrium, the disk D having turned through 90 degrees (one-fourth of a revolution). The bars S1 to S4 are in a vertical position and the masses M2 to M4 are still fastened to the middles of the respective bars S2 to S4.

In FIG. 2D, the masses M1 to M4 have been shifted to the same ends of the respective bars S1 to S4. Torque C that is four times greater has been obtained until the system is once again in equilibrium with the four bars Si in a vertical position and the masses M1 hanging from one end. As shown in FIG. 2D, the disk D has once more turned through 90 degrees (one-fourth of a revolution).

In the present configuration, when the bars Si are fastened directly to the disk, rotation of the disk is limited by the number of bars used for generating rotation of the disk and by the initial orientations of the bars.

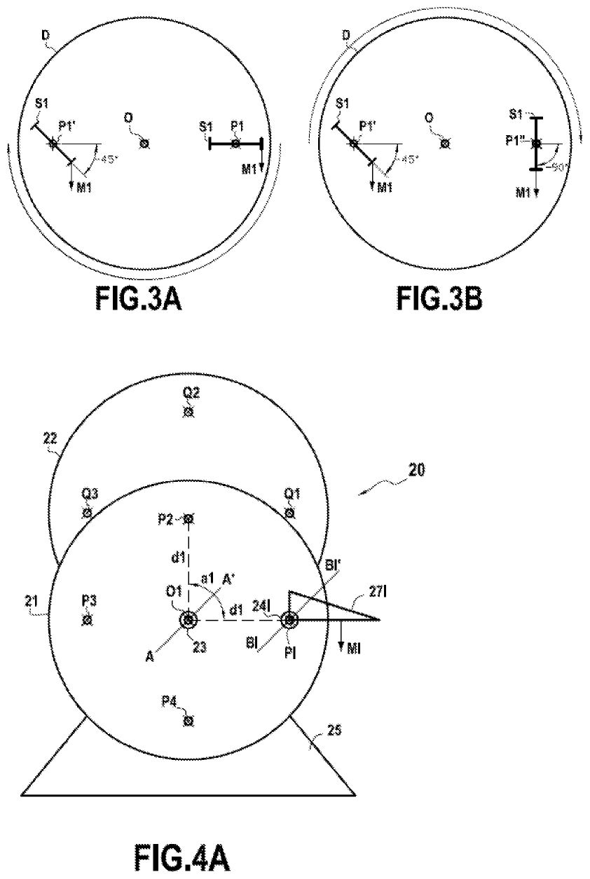

FIGS. 3A and 3B show a second aspect of the operating principle of a rotary device.

As shown in FIGS. 2A to 2D, the angle of rotation of the disk D is limited by the number of bars, by the torque produced by each of the bars, and by the initial orientations of the bars. It may be desirable to increase the angle of rotation of the disk, and consequently the number of revolutions performed by the disk. Reduction gearing (not shown), referred to below as a “reducer” can be used to modify the ratio between the angular speed of rotation of a bar Si and the angular speed of rotation of the disk D so as to increase the angle of rotation of the disk D. The reducer, typically mounted on the rotary shaft of the bar and on the other side of the disk, thus connects the bar Si to the disk D.

FIG. 3A is a diagram showing the rotation of a single bar S1 connected to a reducer having a ratio of 1/4. In its initial position P1, the bar is horizontal. Shifting the mass M1 to the right end of the bar causes the disk D to turn through 180 degrees to an intermediate position P1′. It can be seen that for a gear ratio of 1/4 and for the disk D rotating through 180 degrees, the bar S1 has rotated through −45 degrees.

In order to give an order of magnitude, the change in the angle of inclination of the bar after a certain amount of rotation of the disk, e.g. when the disk turns through 180 degrees and the bar goes from an initial position P1 to an intermediate position P1′, can be determined by subtracting from the starting angle of the bar the angle of rotation of the disk multiplied by the gear ratio. For example, if in the position P1 the bar has an angle relative to the horizontal of 0 degrees, and if the disk turns through 180 degrees and the gear ratio is 1/4, then the final angle of the bar is equal to:

0−(180*1/4)=0−45=−45 degrees

FIG. 3B is a diagram showing the bar S1 after the disk D has rotated through a further 180 degrees, on passing from the intermediate position P1 to the final position P1″ (which in this example corresponds to the initial position P1). The mass M1 has thus continued to drive the disk D in rotation and it can be seen that for a gear ratio of 1/4 and for the disk D rotating through 180 degrees, the bar S1 has rotated through an additional −45 degrees, which corresponds to a total rotation of −90 degrees.

In the present example, the disk D has rotated through one complete revolution with torque exerted by a single bar, instead of through only one-quarter of a revolution as shown in FIG. 2C. Consequently, if a mass Mi is fastened at the one end of a bar Si, the torques C can continue to act on the disk D for longer until the bar Si reaches a vertical equilibrium position.

The number of revolutions performed thus depends on the initial position of the bars, on the value of the gear ratio, which must be less than one (1), and on the value of the torque produced by a bar rotating. the value of the torque, and thus the power, depends on the value of the mass suspended from the bar, on the distance of the mass from the fastener point, and on the number of bars used.

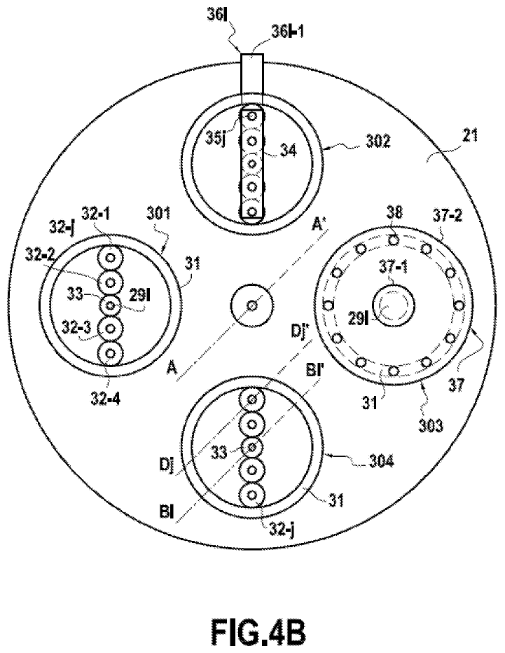

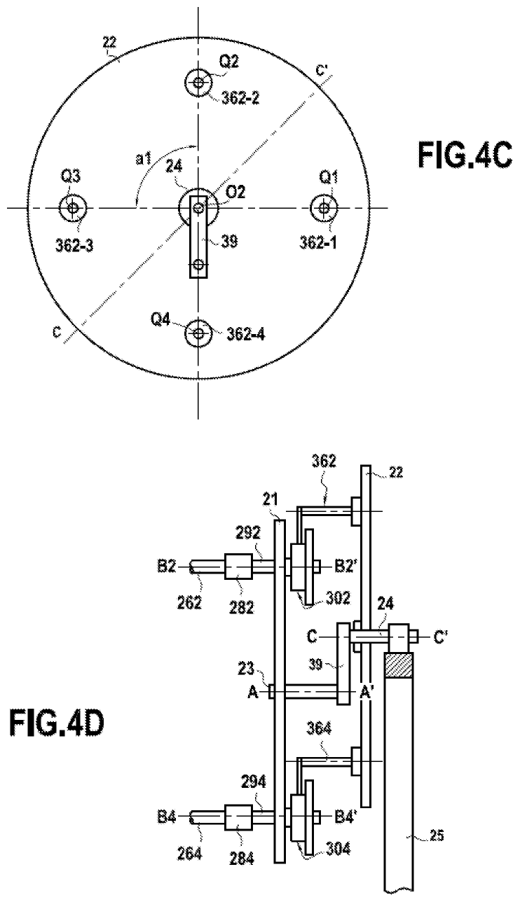

FIGS. 4A to 4D are various views of a rotary device 20 in a first embodiment.

FIG. 4A is a face view of the device 20. The device 20 comprises a first disk (or torque disk) 21, a second disk (or holder disk) 22, a central rotary shaft 23 for the first disk, a central rotary shaft 24 for the second disk (not shown in FIG. 4A), a support element 25, a plurality I of peripheral rotary shafts 26i, and the same plurality I of mass supports 27i, with only the shaft 261 and the support 271 being shown in FIG. 4A for reasons of clarity.

The first disk 21 has a center O1 and can rotate about a central axis of rotation AA′ extending along the rotary shaft 23. The axis AA′ is then perpendicular to the disk 21 and passes through the center O1. Each mass support 27i is fastened by the corresponding peripheral rotary shaft 26i to the disk 21 at a fastener point Pi (in this example P1, P2, P3, P4). Each fastener point Pi is arranged at essentially the same distance d1 from the center O1 of the disk. For each pair of adjacent points Pi, an angle a1 is formed between these two points and the center of the disk D. The angle al formed for each pair of adjacent points Pi is substantially the same. The peripheral rotary shafts 26i are fastened so as to be capable of turning about peripheral axes of rotation BiBi′ (B1B1′, B2B2′, B3B3′, B4B4′), each axis BiBi′ being perpendicular to the disk 21 and passing through the corresponding fastener point Pi. Each mass support 27i includes a mass Mi (M1, M2, M3, M4).

Each rotary shaft 26i has a freewheel 28i for transmitting torque in one direction and for turning freely in the other direction. The freewheel is connected to a coupling shaft 29i passing through the disk 21 and receiving a reducer 30i (none of these being shown in FIG. 4A).

In similar manner, the second disk 22 has a center O2 and can turn about a central axis of rotation CC′ extending along the rotary shaft 24. The axis CC′ is then perpendicular to the disk 22 and passes through the center O2 of the disk. The second disk 22 is mounted on the support element 25. In addition, the second disk 22 has four fastener points Qi (in this example Q1, Q2, Q3, Q4) that are explained below.

As can be seen in FIG. 4A, the disks 21 and 22 are axially offset from each other so that their central axes of rotation AA′ and CC′ do not coincide. This offset may be horizontal, vertical, diagonal, etc. Nevertheless, the configuration in which the disks 21 and 22 are offset vertically from each other enables the weight of the device to be better supported, as described below.

As explained below, rotation of the mass supports 27i about the rotary shafts 26i creates torque that is transmitted to the corresponding reducer 30i via the freewheel 28i and the coupling shaft 29i. Thereafter, the reducer 30i transfers the rotation to the first disk 21. The second disk 22 is connected to the first disk 21 and turns together with the first disk 21.

FIG. 4B is a back view of the first disk 21. The reducers 30i (in this example 301, 302, 303, 304) are mounted on the corresponding coupling shafts 29i. Although each reducer 30i has the same elements, each reducer is shown differently in FIG. 4B in order to distinguish more clearly their various material and immaterial characteristics in different planes. The reducers 30i are geartrains mounted in a vertical plane on a common axis, i.e. in which the rotary inlet and outlet parts have the same axis of rotation.

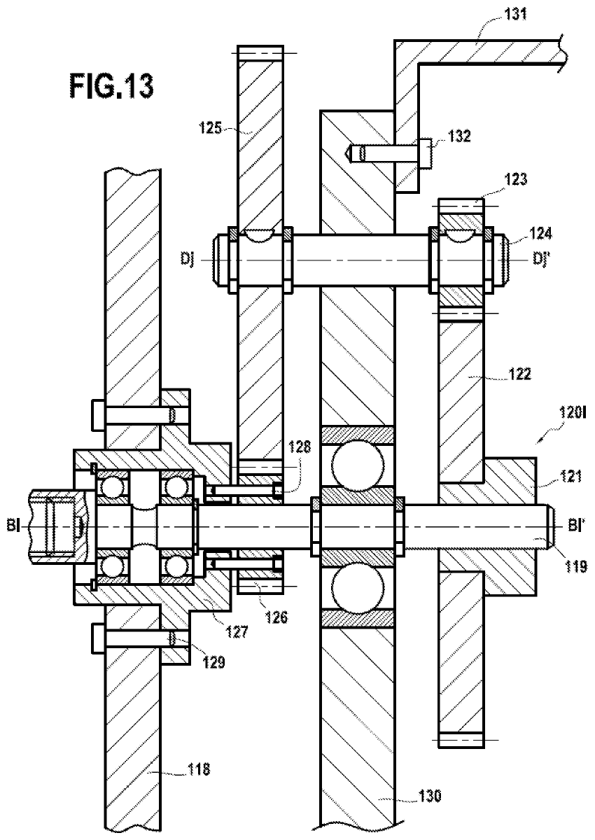

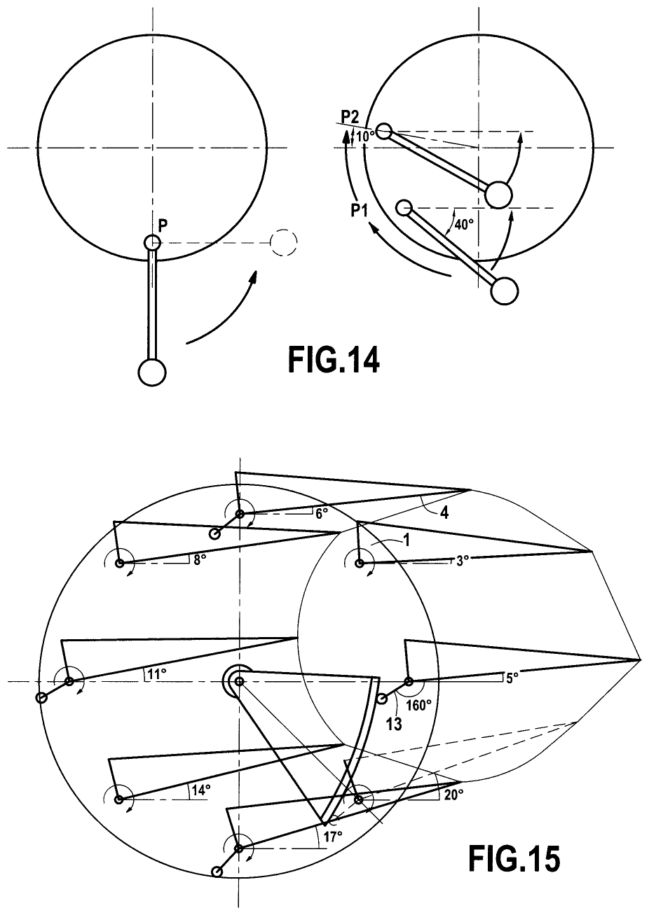

It may be observed that in other embodiments (as explained below with reference to FIG. 13), the reducers may be constituted by geartrains that are not on a common axis, but are on axes that are offset vertically.

As shown with reference to the reducer 301, a reducer comprises a peripheral ring with internal teeth referred to as the “peripheral ring” 31, four planet gears 32-j, where j is the index of each planet gear, in this example in the range 1 to 4 (32-1, 32-2, 32-3, 32-4), and an outlet gear 33 situated all around the coupling shaft 29i. The peripheral ring 31 is connected to the coupling shaft 29i by a centering band (not shown on the reducer 301) and constitutes the inlet of the reducer. The outlet gear 33 is situated around the coupling shaft 29i and constitutes the outlet of the reducer. Finally, the planets 32-1, 32-2 are arranged between the peripheral ring 31 and the outlet gear 33 on one side, while the planets 32-3, 32-4 are arranged between the peripheral ring 31 and the outlet gear 33 on the other side. These planets 32-j transfer motion from the ring 31 to the outlet gear 33. The peripheral ring 31, the planets 32-j and the outlet gear 33 are situated essentially in the same vertical plane. The use of four planet gears 32-j enables the peripheral ring 31 and the outlet gear 33 to turn in the same direction, so that the peripheral rotary shafts 26i and the first disk 21 turn in the same direction.

As shown with reference to the reducer 302, a reducer also has a planet carrier 34 on which the planets 32-j are fastened by support rods 35-j passing through the respective centers of the planets 32-j. A locking part 36i, of which only a first portion 36i-1 extending vertically above the reducer 302 is visible in FIG. 4B, is connected to the planet carrier 34 by the rod 35-1 so as to fasten the axes of rotation of the planets 32-1 to the planet carrier 34. The planet carrier 34 and the first portion 36i-1 of the locking part 36i are located in respective planes situated in front of and behind the vertical plane containing the ring 31, the planets 32-1, 32-2, 32-3, 32-4, and the outlet gear 33.

The locking part 36i also has a horizontal second portion 36i-2 that is shown more particularly in FIGS. 4C and 4D, having one of its ends fastened to the top end of the first portion 36i-1 and having its other end fastened to the second disk 22. The locking part 36i thus enables the position of the planet carrier 34 to be locked relative to the second disk 22, and consequently enables the planets to be in stationary positions.

As shown with reference to the reducer 303, a reducer also has a rotary inlet part referred to as a “fastener part” 37, which connects the coupling shaft 29i to the peripheral ring 31. The fastener part 37 has a first portion 37-1 referred to as a “centering band” that is fastened and centered on the coupling shaft, and a second portion 37-2 that is a cylindrical part carrying the peripheral ring 31 and to which it is fastened by screws 38.

Finally, as shown with reference to the reducer 304, each planet 32-j (32-1, 32-2, 32-3, 32-4) can rotate about its own planet axis of rotation DjDj′ while following the rotation of the first disk 21 about its axis AA′. However, the peripheral ring 31 and the outlet gear 33 can rotate about the axis BiBi′ while following the rotation of the first disk 21 about its axis AA′. In contrast, the planets 32-j (32-1, 32-2, 32-3, 32-4) cannot rotate about the axis BiBi′ since they are blocked in a predetermined position, a vertical position in this example, by the planet carrier 34 and the locking part 36i.

FIG. 4C is a face view of the second disk 22 having the center O2, the rotary shaft 24, and the axis of rotation CC′. In addition, the second disk 22 has four fastener points Qi (in this example Q1, Q2, Q3, Q4), the second portions of the horizontal locking parts 36i-2 (in this example 361-2, 362-2, 363-2, 364-2), and a connection part 39. The fastener points Qi correspond essentially to the fastener points Pi of the first disk, having the same distances d1 from the center of the disk and the same angles al formed between two consecutive fastener points and the center of the disk.

The second portions 36i-2 of the locking parts 36i extend perpendicularly to the plane of the figure and they are fastened at one end to the fastener points Qi and at the other end to the top ends of the first portions 36i-1 of the locking parts of the planet gears, as shown in FIG. 4D. The locking part 36i serves to prevent the planets 32-1, 32-2, 32-3, 32-4 of each reducer arranged on the first disk 21 from moving since the second disk 22 turns at the same speed as the first disk.

Finally, the connection part 39 connects the rotary shaft 23 of the first disk to the rotary shaft 24 of the second disk. The connection part 39 serves mainly to support the rotary shaft of the first disk.

FIG. 4D is a side view of the device 20 of FIG. 4A and it shows the disks 21, 22, the central rotary shafts 23, 24, the support element 25, the peripheral rotary shafts 262, 264, the freewheels 282, 284, the coupling shafts 292, 294, the reducers 302, 304, the locking parts 362, 364, the connection parts 39, and finally the rotary axes AA′, B2B2′, B4B4′, CC″.

As can be seen, the support element 25 is coupled to the rotary shaft 24 of the second disk 22 in order to hold it in a vertical position, while allowing the second disk 22 to turn about its axis CC′. Since the disks 21, 22 are connected together by the connection part 39, and to a lesser extent by the locking part 36i (362, 364), the first disk 21 is supported indirectly by the support element 25.

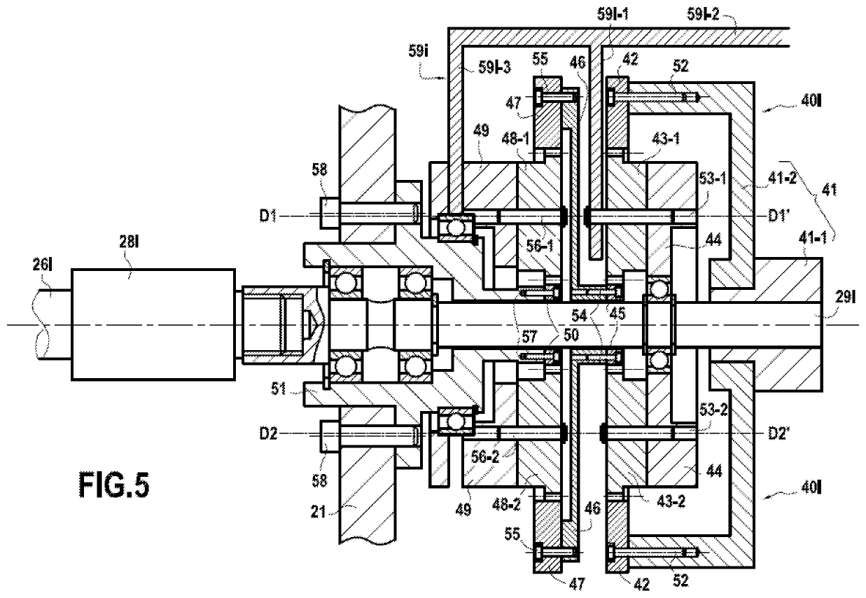

FIG. 5 is a detailed section view of a reducer 40i in an embodiment. More particularly, FIG. 5 shows the first disk 21, a peripheral rotary shaft 26i, a freewheel 28i, a coupling shaft 29i, and the reducer 40i. It should be recalled that the peripheral rotary shaft 26i is driven in rotation by a mass support 27i (not shown in FIG. 5).

The reducer 40i includes a rotary inlet part 41, a peripheral ring having a primary internal gear 42, two primary planet gears 43-1, 43-2, a first planet carrier 44, an outlet gear 45, an intermediate transition part 46, a secondary peripheral ring with an internal gear 47, two secondary planet gears 48-1, 48-2, a second planet carrier 49, an outlet gear 50, and a rotary outlet part 51. The reducer 40i thus has two reduction stages, the first stage comprising the elements 42 to 45 and the second stage comprising the elements 47 to 50, the intermediate part 46 constituting both the rotary outlet part of the first stage and the rotary inlet part of the second reduction stage.

The inlet part 41 has a first portion 41-1 or “centering band” that is fastened and centered on the coupling shaft 29i and a second portion 41-2 that is a cylindrical part carrying the peripheral ring 42 and fastened thereto by screws 52. The inlet part 41 thus transmits rotary motion from the coupling shaft 29i to the primary peripheral ring 42.

The primary peripheral ring 42 is in contact with the outer ends of the primary planet gears 43-1, 43-2, which are suitable for rotating about their respective axes of rotation D1D1′ and D2D2′. In addition, the planets 43-1, 43-2 have their centers fastened to the first planet carrier 44, e.g. by means of respective holder rods 53-1, 53-2. It should be observed at this point that the planet carrier 44 is mounted so as to be capable of facilitating rotation of the coupling shaft relative to the planet carrier, and it may include a ball bearing.

In addition, it should be observed that instead of four planets 32-j as shown with reference to FIG. 4B, each stage has only two planets 43-1, 43-2, 48-1, 48-2. In this configuration, the peripheral ring 42 and the outlet gear 45 turn in opposite directions, but the second reduction stage serves to cause the first disk 21 to rotate in the same direction as the peripheral rotary shaft 26i. The primary planet gears 43-1, 43-2 are in contact at their outer ends with the outlet gear 45, which has an inner end suitable for turning about the coupling shaft 29i. The intermediate part 46 has an inner end coupled to the outlet gear 45 by screws 54 and an outer end coupled to the secondary peripheral ring 47 by screws 55. The intermediate part 46 thus links together the two reduction stages of the reducer 40i.

Likewise, the secondary peripheral ring 47 is in contact with the outer ends of the secondary planet gears 48-1, 48-2, which are suitable for turning about their respective axes of rotation D1D1′ and D2D2′. In addition, the planets 48-1, 48-2 have their centers fastened to the second planet carrier 49, e.g. by means of respective holder rods 56-1, 56-2. Likewise, the planet carrier 49 is mounted so as to facilitate rotation of the coupling shaft relative to the planet carrier, and may include a ball bearing.

The secondary planet gears 48-1, 48-2 are in contact at their inner ends with the outlet gear 50, which is suitable for turning about the coupling shaft 29i and which is coupled to the outlet part 52 by screws 57. The outlet part 51 is coupled to the first disk 21 by a plurality of bolts 58 and includes a ball bearing to facilitate rotation of the first disk about the coupling shaft 29i. Thus, the first disk 21 is driven in rotation by the reducer 40i and the peripheral rotary shaft 26i, which is itself driven in rotation by the mass support.

In similar manner to the explanation with reference to FIGS. 4B to 4D, a locking part 59i connects the planet carriers 44, 49 of the reducer 40i to the second disk 22 so as to prevent the planet carriers 44, 49 from rotating and so as to lock the planets 43-1, 43-2 and 48-1, 48-2 in position without impeding their rotation about the axes D1D1′, D2D2′. The locking part 59i then has a first vertical portion 59i-1 connected to the planet carrier 44, a horizontal portion 59i-2 connected to the second disk 22, and a second vertical portion 59i-3 connected to the planet carrier 49, the top ends of the portions 59i-1, 59i-3 being connected to the horizontal portion 59i-2.

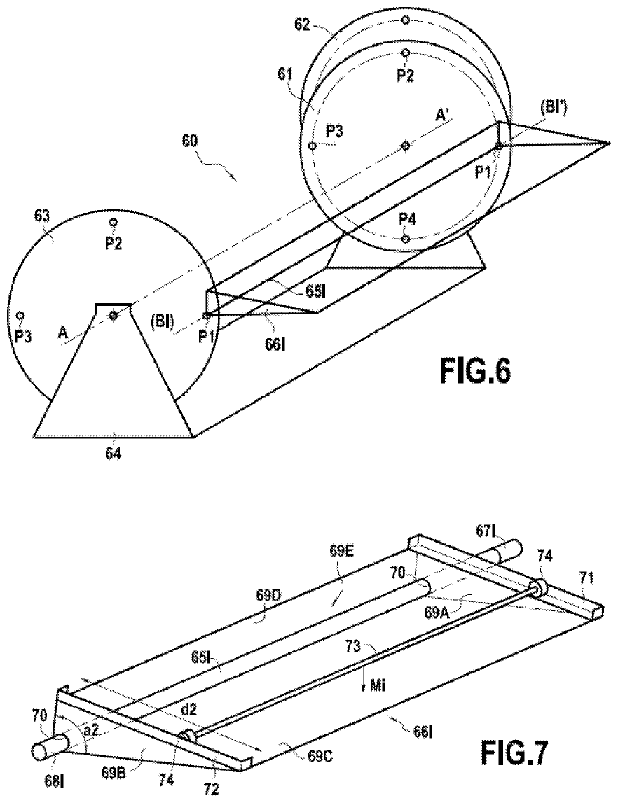

FIG. 6 is a perspective view of a rotary device 60 in another embodiment of the invention. In addition to a first disk 61 and a second disk 62, the rotary device 60 includes a third disk (or support disk) 63 that is arranged facing the first disk 61 and that has the same central axis of rotation AA′.

The disks 61 and 62 are essentially the same as the disks 21 and 22 described with reference to FIGS. 4A to 4D, and they are not described again. The assembly is mounted on a support element 64 that holds the second disk 62, as described with reference to FIG. 4D, and also the third disk 63.

A plurality I of peripheral rotary shafts 65i extends between the disks 61 and 63, and they are mounted at fastener points Pi. The same plurality I of mass supports 66i (only one of which is shown in FIG. 6 for reasons of clarity) are mounted on the rotary shaft 65i, which extends along peripheral axes of rotation BiBi′.

It should be observed at this point that a central rotary shaft could extend between the centers of the disks 61, 63, e.g. for the purpose of better supporting or assisting rotation of the disks, however under such circumstances the dimensions of the mass supports would need to be restricted in order to avoid striking the central rotary shaft during their own rotation.

FIG. 7 is a perspective view of a mass support 66i in an embodiment. In this embodiment, the mass support is in the form of a triangular tray.

One end of the rotary shaft 66i has a freewheel 67i configured to face the first disk 61, while the other end of the rotary shaft is merely a bearing 68i configured to face the third disk 63. Consequently, the third disk 63 serves essentially to support the weight of the mass support which may be several hundreds of kilograms or more, depending on the application under consideration.

The mass support 66i has five faces 69A to 69E. The faces 69A and 69B are plates in the form of right-angle triangles that are arranged at each of the ends of the mass support, facing the disks 61 and 63, respectively. The faces 69A, 69B include holes 70 through which the rotary shaft 65i can pass. The face 69C is a plate extending horizontally that is arranged at the bottom and connected to the horizontal bottom sides of the faces 69A, 69B. The face 69D is a plate extending vertically, being arranged laterally and it connects together the vertical sides of the faces 69A and 69B. The face 69D forms an angle a2 of about 90 degrees with the face 69C. Finally, the face 69E is open and forms the hypotenuse of the triangular shape. The inside space formed by the faces 69A to 69E is empty in order to enable masses to be installed and shifted therein.

On their top sides, the faces 69A and 69B have respective rails 71 and 72 arranged along the hypotenuses of the triangles of angle a2 that is essentially a right angle (90 degrees). A mass bar 73 has wheels 74 supported by the rails 71 and 72, and it can move back and forth along the direction D2. A mass Mi, represented diagrammatically by an arrow, may be constituted by a mass attached to the bar 73 or may be constituted merely by the mass of the bar itself.

It may be observed that after a few revolutions of the device, the mass supports occupy vertical positions, as shown in FIGS. 2D and 3B. The device then stops since there is no longer any torque being applied about the peripheral axes of rotation BiBi′. In order to cause the device to continue to rotate, it is necessary to make use of means enabling the system to be “reinitialized” by reestablishing torque about one or more of the peripheral axes of rotation, e.g. by changing the angle of inclination of the mass support in order to reestablish gravity potential energy and increase the number of revolutions that the device can perform.

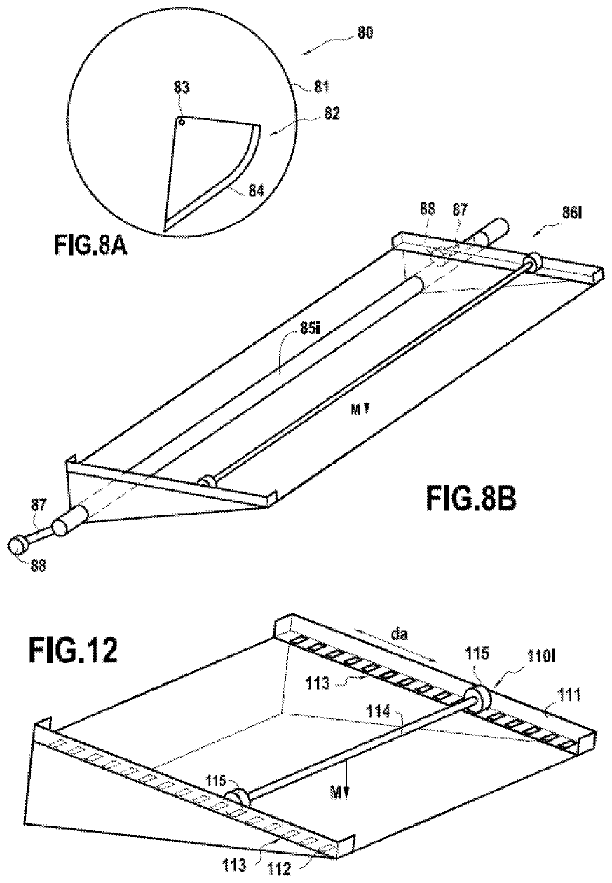

FIG. 8A shows a rotary device 80 in another embodiment that enables the torque of a mass support to be reinitialized. More particularly, FIG. 8A is a face view of a first disk 81 having a cam 82. The cam has a hole 83 enabling the cam to be fastened to the center of the disk 81, and a rim 84 of determined outline. The cam 82 is not driven in rotation, neither by the disk 81 nor by a mass support.

FIG. 8B is a perspective view of a mass support 86i in another embodiment for co-operating with the cam 82. The mass support 86i is arranged on a rotary shaft 85i and corresponds essentially to the support 66i described with reference to FIG. 7, except that the mass support also includes a rod 87 and a follower wheel 88 at its end that is configured to face the first disk 81.

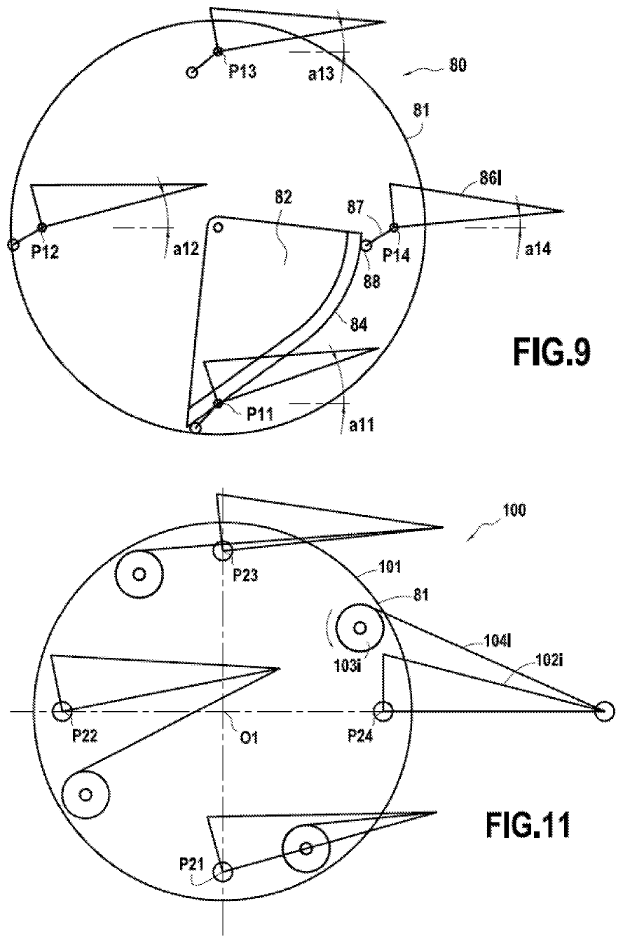

Co-operation between the cam 82 arranged on the first disk 81 and more particularly its rim 84, with the wheel 88 arranged on the mass support 86i enables the angle of the mass support to be varied, as described below with reference to FIG. 9.

At this point, it may be observed that in an embodiment, the third disk is also provided with a cam, and the mass support also has a rod and a wheel arranged facing the third disk. Thus, the third disk assists the first disk in varying the angle of the mass support, which is useful particularly when the mass support supports a large mass.

In another embodiment, the rod 87 and the follower wheel 88 are arranged on the rotary shaft 85i instead of on the mass support 86i.

FIG. 9 is a face view of the rotary device 80 showing the first disk 81 fitted with the cam 82 of FIG. 8A and the mass support 86i fitted with the rod 87 and the follower wheel 88 of FIG. 8B. In this figure, the same mass support 86i is shown in four different positions P11, P12, P13, and P14 during rotation of the first disk about the axis of rotation AA′.

The position P11 is vertical directly below the center O1 of the first disk, at an angle of 0 degrees to the vertical, the position P12 is directly horizontal and to the left of the center O1, at an angle of 90 degrees to the vertical, the position P13 is vertically directly above the center O1, at an angle of 180 degrees to the vertical, and the position P14 is directly horizontally to the right of the center O1, at an angle of 270 degrees to the vertical. The rod and wheel assembly of the mass support 86i comes into contact with the cam 82 at the position P14 (the position of minimum inclination of the tray) and it loses contact with the cam at the position P11 (the position for reinitializing the angle of inclination of the tray).

Consequently, between the positions P11 and P14, the mass support 86i is not constrained by the cam 82 as it rotates about the rotary shaft 85i, whereas between the positions P14 and P11, its rotation is constrained by the cam 82 since the follower wheel 88 of the support 86i is in contact with the rim 84 of the cam, thereby preventing the support from turning in one direction (clockwise in this example) under the effect of the action of the offset mass.

The first disk 81 continues to turn while the follower wheel 88 is bearing against the rim 84 of the cam. Since the rotary shaft 85i of the mass support 86i is terminated by a freewheel, the support can turn freely in the opposite direction (counterclockwise in this example). The angle of inclination of the support is thus modified by the follower wheel 88 sliding along the rim 84, while the first disk 81 continues to rotate downwards.

On losing contact with the cam, in the reinitialization position P11, the support has a maximum angle all relative to the horizontal. Thereafter, at the positions P12, P13, and P14, the angle relative to the horizontal (the angles a12, a13, and a14 in this example) decreases progressively such that a11>a12>a13>a14. To give an idea, if the angle all is about 20 degrees relative to the horizontal, the angles a12 to a14 are respectively 14.4, 8.8, and 3.2 degrees for a gear ratio of 1/16. As explained above with reference to FIGS. 3A and 3B, the change in the angle of inclination of the tray between two positions of the disk, e.g. between the positions P11 and P12, can be determined by subtracting from the starting angle of the tray the angle of rotation of the disk multiplied by the gear ratio, as explained with reference to FIG. 3A. For example, for a reinitialization angle (starting angle) of 20 degrees, there is a difference of 90 degrees between the positions P11 and P12, so with a gear ratio of 1/16, the resulting angle is equal to

20−(90*1/16)=14.4

It should be observed at this point that the transverse dimensions of the mass support may be selected so that the end furthest from the axis of rotation of the support is always positioned beyond the center of the first disk, as can be seen more particularly at the position P12. A mass positioned at the end of the support thus provides “drive” at all instants during the rotary cycle, with improved efficiency. The mass supports do not strike the cam since the cam is arranged between the plate 68A of the support and the face of the first disk.

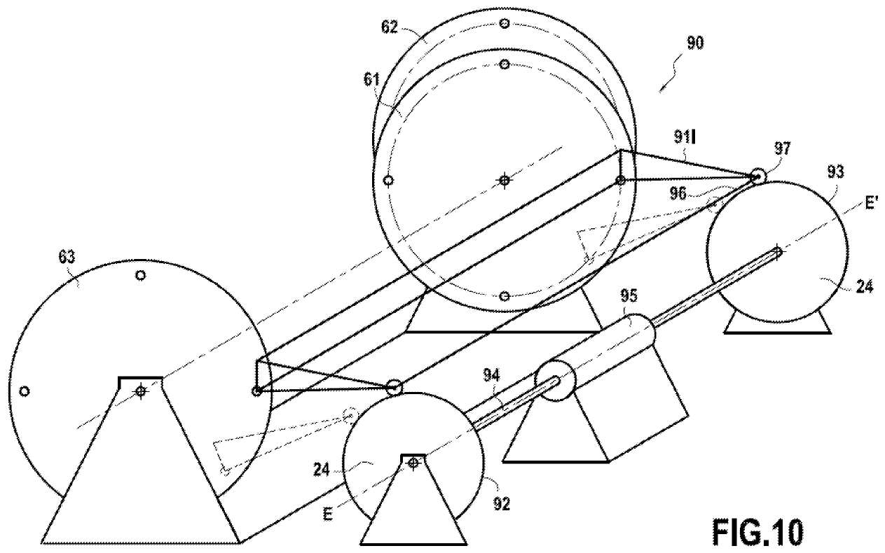

FIG. 10 is a perspective view of a rotary device 90 in another embodiment that enables the torque of the mass support to be reinitialized. The device has the disks 61, 62, 63 as described with reference to FIG. 6, mass supports 91i (only one of which is shown in FIG. 10 for reasons of clarity), and two “external” cams 92, 93.

The cams 92 and 93 are connected together by a rotary shaft 94, that is rotatable about an axis of rotation EE′. A motor 95 is connected to the rotary shaft 94 in order to cause it to rotate and consequently to rotate the cams 92 and 93.

The mass support 91i has rods 96 and wheels 97 arranged on the outer ends of the support so as to come into contact with the cams 92 and 93. Rotating the cams about the axis EE′ serves to facilitate reinitializing the angle of inclination of the mass support 91i. The wheels 97 do not slide along the periphery of the cams 92, 93. On the contrary, the position of the wheel 97 is stationary relative to the periphery of the disk. The motor 95 drives rotation of the rotary shaft 94 and of the cams 92, 93 in one direction (counterclockwise in this example). Rotation of the external cams cancels the gravity mass of the support and the torque of the support about its peripheral axis, modifies the path followed by the wheels, and reinitializes the angle of inclination of the support.

FIG. 11 shows a rotary device 100 in another embodiment that enables the torque of a mass support to be reinitialized. The device comprises a first disk 101, a plurality I of mass supports 102i, and the same plurality I of motor-driven devices 103i arranged on the first disk 101. Each motor-driven device 103i is connected to the outer end of a corresponding mass support by a cable 104i.

In this figure, the same mass support 102i and the same motor-driven device 103i are shown in four different positions P21, P22, P23, and P24 during rotation of the first disk about the axis of rotation AA′. In this figure, the position P21 is vertically directly below the center O1 of the first disk, at an angle of 0 degrees to the vertical, P22 is directly horizontally to the left of the center O1 at an angle of 90 degrees to the vertical, P23 is vertically directly above the center O1 at an angle of 180 degrees to the vertical, and P24 is directly horizontally to the right of the center O1, at an angle of 270 degrees to the vertical.

Between the position P24 (the minimum inclination position of the tray) and the position P21 (the position for reinitializing the angle of inclination of the tray), the motor-driven device 103i is engaged and exerts traction on the cable 104i that enables the angle of inclination of the mass support 102i to be modified. In contrast, between the positions P21 and P24, the cable 104i remains tensioned but does not impede rotation of the mass support.

In order to enable the cable 104i to remain tensioned while enabling the mass support 102i to turn in one direction (clockwise in this example) and exert torque, the device 103i also includes a pulley over which the cable 104i slides, a return spring, and a freewheel (not shown in FIG. 11).

In an embodiment, the motor 103i is engaged by detecting that the first disk is passing through the position P24 by means of optical or electromagnetic sensors known to the person skilled in the art. In similar manner, the motor 103i is stopped on detecting that the first disk is passing through the position P21.

FIG. 12 is a perspective view of a mass support 110i in another embodiment, in which the support itself includes means for modifying the center of gravity of its mass M. The mass support 110i is similar to the mass support described above with reference to FIG. 7. The mass support 110i includes rails 111 and 112, and a plurality of “electromagnetic chocks” 113 arranged along the direction d2 on each rail. The chocks 113 are remotely controlled and they move up and down as a function of electrical control currents.

A mass-carrier bar 114 with wheels 115 at its ends can slide along the rails 111 and 112 by means of the wheels 115. The position of the mass-carrier bar on the rails may be blocked by two electromagnetic chocks that are raised on both sides of the two wheels 115, or on one side only, leaving the bar free to move between one end of the rail and the chock.

When all of the chocks are lowered, the mass-carrier bar 114 can move along the rails 111, 112 because of the angle of inclination of the mass support 110i. The position of the mass-carrier bar is blocked once more when the chocks are raised again.

Since the angle of inclination of the support can change, the mass-carrier bar when free to move can move away from the axis of rotation of the tray, or on the contrary can move towards it. On moving towards it, the torque diminishes, whereas on moving away therefrom the torque increases. When the mass-carrier bar is positioned vertically relative to the axis of rotation of the mass support, there is no torque, ignoring the mass of the support itself.

It is thus possible to control the value of the torque that is applied to the disk by releasing or by blocking the mass-carrier bar for a predetermined angle of inclination of the mass support. The drive force of the system can thus be controlled and adjusted remotely with the help of the force of gravity.

Furthermore, the angle of inclination of the mass support may be selected to be relatively small, as described above with reference to the example of FIG. 7, so as to make it easier to adjust the position of the mass-carrier bar along the rail.

FIG. 13 is a detailed section view of a reducer 120i in an embodiment. More particularly, FIG. 13 shows a first disk 118, a coupling shaft 119, and the reducer 120i. It should be recalled that the coupling shaft 119 is driven in rotation by a mass support mounted on a peripheral rotary shaft that is connected to the coupling shaft via a freewheel (all of which are not shown in FIG. 13).

The reducer 120i has a rotary inlet part 121 or “centering band” that is fastened and centered on the coupling shaft 119, a first gear 122, a second gear 123, an additional coupling shaft 124, a third gear 125, a fourth gear 126, and a rotary outlet part 127. The fourth gear 126 is connected to the outlet part 127 by screws 128, and the outlet part 127 is coupled to the first disk 118 by a plurality of bolts 129 and includes a ball bearing to facilitate rotation of the first disk about the coupling shaft 119.

The gears 122, 126 are rotary about the axis BiBi′. The gears 123, 125 are rotary about the axis DjDj′ and they are coupled at their centers by the additional coupling shaft 124. The first gear 122 and the second gear 123 mesh at their outsides, and the third gear 125 and the fourth gear 126 likewise mesh at their outsides. Consequently, the gear 120i does not have a peripheral ring, nor does it have planet gears, unlike the gear described with reference to FIG. 5.

Consequently, rotation of the coupling shaft 119 is transmitted consecutively to the rotary inlet part 121, to the first gear 122, to the second gear 123, to the additional coupling shaft 124, to the third gear 125, to the fourth gear 126, to the outlet part 127, and to the disk 118.

The gear 120i also has a blocking part 130, and a locking part 131 that is connected to the blocking part 130 by a screw 132. The additional coupling shaft 124 passes through the blocking part 130 and can turn about the axis DjDj′ but cannot turn about the axis BiBi′ because of the locking part 131, which is connected to the second disk, as described with reference to FIGS. 4B to 4D, for example. The coupling shaft 119 also passes through the blocking part 130 and can turn about the axis BiBi.

The invention also provides a method of assembling a gravity rotary device as described above.

The assembly method comprises the following steps:
a step S1 of mounting a first disk, e.g. on a support;
a step S2 of mounting at least one peripheral rotary shaft on the first disk, the peripheral rotary shaft being arranged at a distance from a central axis (AA′) of the first disk, being suitable for turning about a peripheral axis of rotation (BiBi′) that is parallel to the central axis and that is coupled to the first disk;
a step S3 of mounting reduction gearing 30i, 40i; 120i between the peripheral rotary shaft and the first disk;
a step S4 of mounting locking means for fastening at least a portion of the reduction gearing in a stationary position in order to prevent it from turning about the peripheral axis of rotation;
a step S5 of mounting a freewheel on the peripheral rotary shaft;
a step S6 of mounting at least one mass support on the peripheral rotary shaft; and
a step S7 of mounting means for modifying the angle of inclination of the mass support on the peripheral rotary shaft.

It should be understood that these steps may be performed in a different order. For example, a mass support may be mounted on a rotary shaft before mounting the shaft on the first disk, the reduction gearing may be mounted on the rotary shaft after mounting the freewheel, etc.

Furthermore, the assembly method may include steps of mounting a second disk on the support, of connecting means for fastening the portions of the reduction gearing to the second disk, of mounting a third disk facing the first disk, etc.

The person skilled in the art will understand that the above-described embodiments may be subjected to modifications, and in particular to the following modifications.

It should be observed at this point that a system for recovering the energy produced by rotation of the rotary device may be coupled to the rotary device, e.g. via the central rotary shafts.

In an embodiment, the device includes a motor coupled to each peripheral rotary shaft, e.g. on the outside of the third disk, which motor is suitable for causing the shaft to rotate in the direction opposite to the direction of rotation of the first disk (counterclockwise in this example). The motor may be fitted with control means enabling the motor to be started at an appropriate moment. The control means may comprise, for example, a sensor that detects the angular position of the rotary shaft relative to the centers of the disk, or a timer set to the time of rotation of the disk.

In an embodiment, the device has a plurality of means for modifying inclination angle, e.g. both internal and external cams, an internal cam and a motor coupled to the rotary shaft, etc.

Although the rotary device is described above as having a plurality of mass supports, the person skilled in the art will understand that a single mass support suffices to cause the device to turn, at least in part, as described with reference to FIGS. 3A, 3B. Under such circumstances, a plurality of means for changing the angle of inclination of the support may be arranged around the device in order to interact regularly with the single mass support.

Furthermore, it should be observed that there is no need for the rotary shaft of the first disk and of the second disk to be connected together. The locking part may suffice to support the first disk and cause the second disk to turn, depending on the weights and the dimensions of the disk.

In addition, it should be observed that instead of locking parts connected to the second disk, the locking parts could be connected to stationary points of the first disk, to a ring surrounding the reducer and turning in the opposite direction, to a groove formed in a support, etc. Under such circumstances, the second disk is not essential.

In addition, it should be observed that the second disk could have its central axis of rotation arranged coaxially with the central axis of rotation of the first disk.

Naturally, the mass support could be of a variety of shapes, e.g. being made as single pieces, extending over two dimensions only, comprising interconnected tubes instead of plates, etc.

In addition, the number of planet gears may be varied, depending on the gear ratio, on the number of reduction stages, etc. Similarly, the number of reduction stages may vary.

Instead of electromagnetic chocks, as shown in FIG. 12, it is possible to devise a kind of “sliding belt” to which a mass is fastened, and a motor for moving the belt.

In an embodiment, the rotary inlet and/or outlet parts may be gears connected directly to the rotary shafts and/or to the disks.

### Operational Principle

On a support ring of 56 cm diameter with a centre O, is installed at the periphery via a unidirectional gear; a bar with a length greater than that of the radius (39 cm) carrying a mass of 500 g to its end.

This bar is positioned vertically from the lowest point “P” on the support, if the bar is positioned horizontally; this causes the rotation of the support which will oscillate for a few moments and start to balance at the point “P1” after having rolled over 60° of arc. The bar ends at an angle of 40° with the horizontal.

If the operation is repeated by setting the bar horizontally at the point P1, the support again comes into rotation and stabilizes at the point P2 having further rolled 40° of arc.

With the third test, the bar passes the top, makes a complete revolution before stopping after several oscillations.

Conclusion: The motor masses installed at the periphery produce sufficient energy to drive the rotating support.

With this architecture, the masses installed on the upward side can be motor to the extent that they produce an eccentric motor torque.

Potential uses: the rotary device can be coupled to another rotary device, so that the energy created by the rotary device on one or more of its support disks can be recovered by a clutch mechanism, a gear mechanism or a belt or chain transmission mechanism for running electricity generators, pumps or compressors, wind turbines, tidal turbines, water turbines.

### Test No. 1:

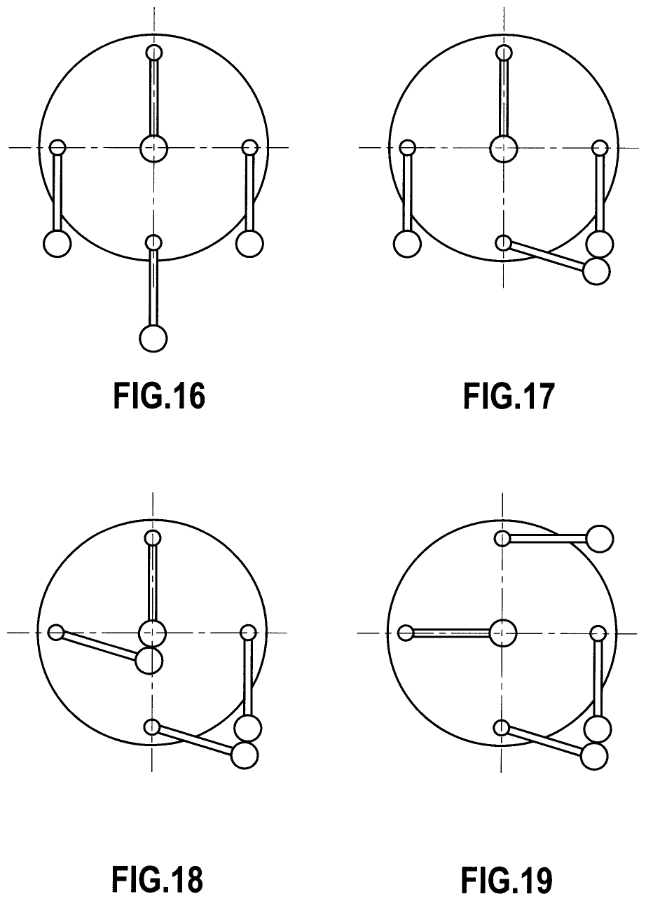

Four mass bars installed in a cross on a support of 56 cm diameter with bars of 24 cm length and an implantation radius of 19 cm and masses of 500 gr at the ends, as shown in the balance configuration (FIG. 16).

The test is performed under most unfavourable conditions: the system is off, the mass located at the lowest point of the support is implemented without any other source of energy likely to cause rotational support (FIG. 17).

The support rotates for five seconds (two complete rotations) before stopping.

### Test No. 2:

The mass located on the upward side is placed in the driving position (FIG. 18). The support rotates for seven seconds (three complete rotations) before stopping.

### Test No. 3:

The highest bar is positioned horizontally and its torque increases (FIG. 19). The support rotates for eleven seconds (three complete rotations) before stopping.

### Test No. 4:

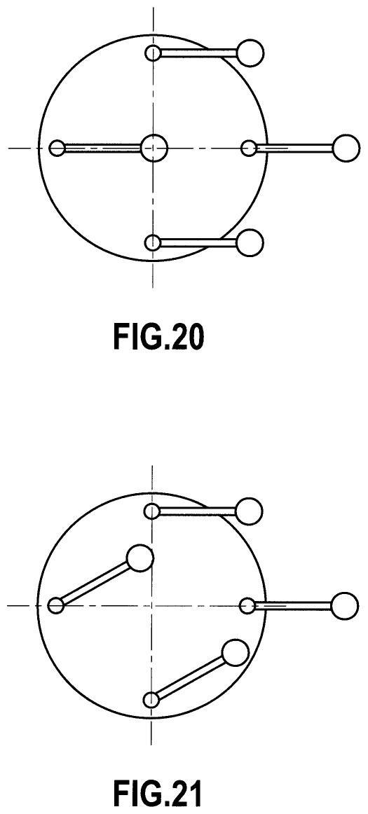

The four bars are positioned horizontally under a driving position (FIG. 20). The support rotates for fourteen seconds (seven complete rotations) before stopping.

### Test No. 5:

This corresponds to the geometric configuration close to that in operation (FIG. 21). The support rotates for sixteen seconds (9 complete rotations) before stopping.

TABLE 1
Desired power and support configuration

| | | | | Tangential | | | | Mass |
|---|---|---|---|---|---|---|---|---|
| | | | | Velocity | | | Width | (tons) |
| | | | | at 30 | | | (meters | to be |
| Power | Power | | Diameter | turns/min | kg | kg by | of the | installed by |
| MW | CV | kg/s | (m) | (m/s) | needed | support | support) | support |
| 1.5 | 2040 | 153 000 | 6 | 10 | 15 300 | 3825 | 4 | 0.956 |
| 1.5 | 2040 | 153 000 | 8 | 12 | 12 750 | 3187 | 6 | 0.531 |
| 1.5 | 2040 | 153 000 | 10 | 15 | 10 200 | 2550 | 8 | 0.318 |
| 2 | 2730 | 204 750 | 6 | 10 | 20 475 | 5120 | 4 | 1.280 |
| 2 | 2730 | 204 750 | 8 | 12 | 17 062 | 4265 | 6 | 0.710 |
| 2 | 2730 | 204 750 | 10 | 15 | 13 650 | 3412 | 8 | 0.426 |
| 3 | 4100 | 307 500 | 6 | 10 | 30 750 | 7687 | 4 | 1.921 |
| 3 | 4100 | 307 500 | 8 | 12 | 25 625 | 6406 | 6 | 1.067 |
| 3 | 4100 | 307 500 | 10 | 15 | 20 500 | 5125 | 8 | 0.640 |
| 4 | 5460 | 409 500 | 6 | 10 | 40 950 | 10 237 | 4 | 2.559 |
| 4 | 5460 | 409 500 | 8 | 12 | 34 125 | 8531 | 6 | 1.421 |
| 4 | 5460 | 409 500 | 10 | 15 | 27 300 | 6825 | 8 | 0.853 |

Table 1 provides details for a desired power between 1.5 and 4 MW with support of 6, 8, or 10 meters of diameter, and indicates for each case the size of the support and the value of the masses needed to obtain the desired power.

1. A gravity rotary device comprising:
a first disk comprising:
a central axis about which the first disk is capable of turning; and
at least one peripheral axis of rotation arranged at a distance from and parallel to the central axis;
at least one peripheral rotary shaft arranged at a distance from the central axis of the first disk, and suitable for turning about the peripheral axis of rotation, parallel to the central axis, and coupled to the first disk; and
a motor connected to the peripheral rotary shaft, to cause the peripheral rotary shaft to rotate about the peripheral axis of rotation;
at least one mass support mounted on the peripheral rotary shaft and having a mass suitable for being moved away from the rotary shaft in order to produce torque causing the rotary shaft and consequently the first disk to pivot;
reduction gearing for reduction from the first disk to the mass support, the gearing being arranged between the peripheral rotary shaft and the first disk, the gearing comprising a rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk;
means for fastening at least a portion of the reduction gearing in a stationary position in order to prevent the reduction gearing from turning about the peripheral axis of rotation;
a freewheel arranged on the peripheral rotary shaft;
means for modifying the angle of inclination of the mass support on the peripheral rotary shaft relative to the horizontal passing through the peripheral axis of rotation of the shaft; and
means for resetting the device.

2. The device according to claim 1, wherein:
the reduction gearing further comprises:
a peripheral ring connected to the rotary inlet part;
an outlet gear connected to the rotary outlet part; and
at least one planet gear arranged between the peripheral ring and the outlet gear; and
the means for fastening at least a portion of the reduction gearing further comprises planet carriers fastened to the planet gears and locking parts fastened to the planet carriers.

3. The device according to claim 1, further comprising a second disk suitable for turning about a central axis and coupled to the first disk so that rotation of the first disk entrains rotation of the second disk;
the means for fastening the portion of the reduction gearing being coupled to the second disk.

4. The device according to claim 3, wherein the central axis of the second disk is off-center relative to the central axis of the first disk.

5. The device according to claim 1, comprising:
at least two peripheral rotary shafts, each being arranged at substantially the same distance from the central axis of the first disk and having a peripheral axis of rotation parallel to the central axis, coupled to the first disk, and angularly equidistant relative to the center of the first disk; and
at least two mass supports, each mounted on a peripheral rotary shaft and having a mass suitable for being moved away from the peripheral rotary shaft in order to produce torque causing the peripheral rotary shaft, and consequently the first disk, to rotate.

6. The device according to claim 3, wherein:
the first disk includes a central rotary shaft; and
the second disk includes a central rotary shaft;
the central rotary shafts being connected together by a connection part.

7. The device according to claim 6, further comprising a support element connected to the central rotary shaft of the second disk while enabling the first disk and the second disk to turn.

8. The device according to claim 1, further comprising a third disk arranged facing the first disk, suitable for turning about the central axis of the first disk, and supporting one end of the at least one peripheral rotary shaft.

9. The device according to claim 1, wherein the means for modifying the angle comprises:
an internal cam having a guide surface and arranged on the first disk; and
a follower wheel arranged on an inner surface of a mass support and suitable for coming into contact with the guide surface of the cam during rotation of the first disk in order to guide the rotation of the mass support in the direction opposite to the direction of rotation of the first disk, by virtue of the freewheel, and in order to change the angle of inclination of the mass support.

10. The device according to claim 1, wherein the means for modifying the angle comprises:
at least one external cam arranged facing the outer end of a mass support and including a guide surface; and
a follower wheel arranged on an outer surface of a mass support and suitable for coming into contact with the guide surface of the cam during rotation of the first disk in order to guide the rotation of the mass support in the direction opposite to the direction of rotation of the first disk, by virtue of the freewheel and in order to change the angle of inclination of the mass support.

11. The device according to claim 1, wherein the mass support comprises two plates of triangular shape that are arranged at a distance apart from each other and in parallel planes, the plates being connected to each other by longitudinal support elements, with the top sides of the plates having rails; and
wherein a mass-carrier bar is supported at its two ends by the rails and is suitable for moving along a direction along the top sides of the plates.

12. The device according to claim 11, wherein each of the rails of the mass support includes a plurality of electromagnetic chocks suitable for rising in order to block movement of the mass-carrier bar and for lowering in order to allow the mass-carrier bar to move along the top sides of the plates.

13. A method of rotating a gravity rotation device according to claim 1, the method comprising the steps of:
moving the mass of the mass support away from the peripheral rotary shaft in order to produce torque causing the peripheral rotary shaft to pivot and consequently causing the first disk to pivot; and
modifying the angle of inclination of the mass support on the peripheral rotary shaft relative to the horizontal passing through the peripheral axis of rotation of the shaft.

14. A method of assembling a gravity rotation device according to claim 1, the method comprising the steps of:
mounting the first disk comprising:
the central axis about which the first disk is capable of turning; and
the at least one peripheral axis of rotation arranged at the distance from and parallel to the central axis;
mounting the at least one peripheral rotary shaft arranged at the distance from the central axis of the first disk, and suitable for turning about the peripheral axis of rotation, parallel to the central axis, and coupled to the first disk;
mounting the motor on the peripheral rotary shaft, to cause the peripheral rotary shaft to rotate about the peripheral axis of rotation;
mounting the reduction gearing for reduction from the first disk to the mass support, the gearing being mounted between the peripheral rotary shaft and the first disk, the reduction gearing comprising the rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk;
mounting the means for fastening at least the portion of the reduction gearing in the stationary position in order to prevent the reduction gearing from turning about the peripheral axis of rotation;
mounting the freewheel on the peripheral rotary shaft;
mounting the at least one mass support on the peripheral rotary shaft, the mass support having the mass suitable for being moved away from the rotary shaft in order to produce torque causing the rotary shaft to pivot;
mounting the means for modifying the angle of inclination of the mass support on the peripheral rotary shaft relative to the horizontal passing through the peripheral axis of rotation of the shaft; and
mounting the means for resetting the device.

15. A gravity rotary device comprising:
a first disk comprising:
a central axis about which the first disk is capable of turning; and
at least one peripheral axis of rotation arranged at a distance from and parallel to the central axis;
at least one peripheral rotary shaft arranged at a distance from the central axis of the first disk, and suitable for turning about the peripheral axis of rotation, parallel to the central axis, and coupled to the first disk; and
at least one mass support mounted on the peripheral rotary shaft and having a mass suitable for being moved away from the rotary shaft in order to produce torque causing the rotary shaft and consequently the first disk to pivot;
a reduction gearing for reduction from the first disk to the mass support, the gearing being arranged between the peripheral rotary shaft and the first disk, the gearing comprising a rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk;
means for fastening at least a portion of the reduction gearing in a stationary position in order to prevent it from turning about the peripheral axis of rotation;
a freewheel arranged on the peripheral rotary shaft; and
means for modifying the angle of inclination of a mass support on the peripheral rotary shaft relative to the horizontal passing through the peripheral axis of rotation of the shaft;
wherein the means for modifying the angle comprises:
at least one external cam arranged facing the outer end of a mass support and including a guide surface;
a follower wheel arranged on an outer surface of a mass support and suitable for coming into contact with the guide surface of the cam during rotation of the first disk in order to guide the rotation of the mass support in the direction opposite to the direction of rotation of the first disk, by virtue of the freewheel and in order to change the angle of inclination of the mass support;
a motor connected to the external cam and suitable for driving the cam in rotation about an axis of rotation of the cam in the same direction as the direction of rotation of the first disk; and
means for resetting the device.

16. A method of assembling a gravity rotation device, the method comprising the steps of:
mounting a first disk comprising:
a central axis about which the first disk is capable of turning; and
at least one peripheral axis of rotation arranged at a distance from and parallel to the central axis;
mounting at least one peripheral rotary shaft arranged at a distance from the central axis of the first disk, and suitable for turning about the peripheral axis of rotation, parallel to the central axis, and coupled to the first disk;
mounting a motor on the peripheral rotary shaft, to cause the peripheral rotary shaft to rotate about the peripheral axis of rotation;
mounting a reduction gearing for reduction from the first disk to the mass support, the gearing being mounted between the peripheral rotary shaft and the first disk, the reduction gearing comprising a rotary inlet part connected to the peripheral rotary shaft and a rotary outlet part connected to the first disk, the rotary inlet and outlet parts being on the same axis, the reduction gearing enabling the rotation of the peripheral rotary shaft to be transmitted to the first disk;
mounting a means for fastening at least a portion of the reduction gearing in a stationary position in order to prevent the reduction gearing from turning about the peripheral axis of rotation;
mounting a freewheel on the peripheral rotary shaft;
mounting at least one mass support on the peripheral rotary shaft, the mass support having a mass suitable for being moved away from the rotary shaft in order to produce torque causing the rotary shaft to pivot; and
mounting a means for modifying the angle of inclination of the mass support on the peripheral rotary shaft relative to the horizontal passing through the peripheral axis of rotation of the shaft; and
mounting a means for resetting the device.
wherein the means for modifying the angle comprises:
at least one external cam arranged facing the outer end of a mass support and including a guide surface;
a follower wheel arranged on an outer surface of a mass support and suitable for coming into contact with the guide surface of the cam during rotation of the first disk in order to guide the rotation of the mass support in the direction opposite to the direction of rotation of the first disk, by virtue of the freewheel and in order to change the angle of inclination of the mass support; and
a motor connected to the external cam and suitable for driving the cam in rotation about an axis of rotation of the cam in the same direction as the direction of rotation of the first disk.

17. The device according to claim 1, wherein the means for resetting the device can include a cam and rolling roller system, outer cams and a motor, and a motor and cable system.
